(19) United States
(12) Patent Application Publication
(10) Pub. No.: US 2022/0003366 A1
(43) Pub. Date: Jan. 6, 2022

(54) DIVIDABLE LED BAR AND LED LIGHTING DEVICE INCLUDING CONNECTOR FOR THE SAME

(71) Applicant: HELLOMISTERLEE, Daejeon (KR)

(72) Inventors: Sang Hun LEE, Nonsan-si (KR); Seung Bum HONG, Yecheon-gun (KR)

(73) Assignee: HELLOMISTERLEE, Daejeon (KR)

(21) Appl. No.: 17/291,252

(22) PCT Filed: Oct. 15, 2019
(86) PCT No.: PCT/KR2019/013502

§ 371 Date: May 4, 2021

(30) Foreign Application Priority Data
Nov. 5, 2018 (KR) 10-2018-0134805
Jul. 9, 2019 (KR) 20-2019-0002873

(51) Int. Cl. F21S 4/28; F21V 23/00; F21V 23/06

(52) U.S. Cl. CPC F21S 4/28; F21V 23/002; F21Y 2115/10; F21V 23/06; F21V 23/004

(57) ABSTRACT

The present invention relates to an LED lighting device which may comprise: an LED bar in which LEDs are mounted at predetermined intervals on a printed circuit board, and pairs of LED bar connection terminals are formed at predetermined intervals on the top and bottom of the printed circuit board on which the LEDs are mounted, wherein the LED bar is dividable into unit LED bars having a predetermined length by cutting the center of each pair of LED bar connection terminals; and connectors for connecting the unit LED bars. Accordingly, the present invention enables the LED bar to be used by being cut into a predetermined length and enables easy connection of the LED bar by means of connectors, and thus, it is possible to easily form an LED light in the shape of a figure or a letter of a design desired by a user and to obtain the effect of being able to usefully utilize the LED light in interior design, shop promotion, etc.

### FIELD OF INVENTION

The present invention relates to an LED lighting device, more particularly, an LED lighting device which includes an LED bar that can be dividedly used and a connector for connecting the LED bar, wherein an LED bar protective casing and the LED bar provided therein can be easily cut without a separate cutting tool.

### BACKGROUND OF INVENTION

In general, a lighting device uses fluorescent lamps, incandescent lamps, mercury lamps, sodium lamps, etc. as a light source generating light in order to provide lighting directly or indirectly. However, in recent years, LED lighting devices using LEDs (Light Emitting Diodes) that can emit light with low power consumption and high luminance have been developed and used.

The most useful one of the LED lighting devices is a bar-type LED lighting device using an LED bar mounted with a plurality of LEDs spaced apart in a longitudinal direction on a strip-shaped printed. circuit board. Such a bar type LED lighting device is used for various purposes such as lighting for billboards, landscape lighting, etc.

The bar-type LED lighting device as described above includes an LED bar provided with a plurality of LEDs spaced apart in a longitudinal direction, which is mounted on a strip-shaped printed circuit board, as well as a power input terminal which is mounted in a rectangular housing-shaped casing extending in a longitudinal direction.

In such a bar-type LED lighting device, the power input terminal extends a predetermined length while being connected on the printed circuit board by soldering, and is exposed to the outside of the housing. Therefore, there was a disadvantage of consuming time and effort and, when separating the soldered wire from the printed circuit board to supply power from the power input terminal of the printed circuit board, heat must be applied to the soldering part in order to dissolve lead and the wire, which is not only very cumbersome but also causes damage to electronic components due to high heat required to melt lead.

On the other hand, when the electric wire is cut and separated, there are problems that the cut electric wire remains in the soldered portion and the electric wire is shortened by the cut length. Due to this, a volume of the soldered portion in the power input terminal of the printed circuit board is increased, causing short circuit. At the same time, a length of the wire connected to the power input terminal is decreased, hence having difficulties in reusing the same and eventually causing waste of wires.

As solutions to overcome these problems, Korean Patent Laid-Open Publication No. 10-2011-0001478 (Jan. 6, 2011) proposed an LED bar socket and Korean Patent Laid-Open Publication No. 10-2014-94413 (Jul. 30, 2014) disclosed an LED bar having a structure enabling block assembly.

The LED bar socket proposed in Korean Patent Laid-Open Publication No. 10-2011-0001478 (Jan. 6, 2011) is configured to be detachably connected to a socket body at one end of the printed circuit board so as to supply power to the strip-shaped printed circuit board.

However, such a conventional structure requires a separate connector insertion mole and a separate connector, such that the separate connector with a wire connected to the socket body is inserted into a connector hole formed in the socket body so as to allow power to be connected. Further, in the case of coupling the wire to the connector, components are increased and a soldering process is required, that is, a separate soldering process or a separate coupling member is required, hence consuming more working time and cost. Moreover, for the above reasons, productivity is lowered and workability is reduced due to installation work.

In addition, the LED bar having a structure enabling block assembly according to Korean Patent Laid-Open Publication No. 10-2014-94413 (Jul. 30, 2014) is provided with a connection terminal on the end of a unit LED bar equipped with a printed circuit board on which LEDs are mounted, thereby enabling connection without any separate wire, so that beautiful appearance, lighting and advertising efficiency may be maximzed when installing an advertisement panel, interior decoration and/or exterior wall. However, since the unit LED bar has a predetermined length, lots of unit LED bars should be provided when installing the advertisement panel, interior decoration and/or exterior wall. Further, when connection failure occurs for the above reason, operation of the LED bar is impossible.

### SUMMARY OF INVENTION

### Technical Problem to be Solved

An object of the present invention is to provide an LED lighting device, including: a dividable and useable LED bar provided with unit LED bars, which can be cut to a predetermined length and used; and a connector which can easily connect the unit LED bars.

Further, another object of the present invention is to provide an LED lighting device that allows a power supply wire to be coupled to a connection terminal of a connector (“connector terminal”) without any separate operational tool or the like, thereby reducing working time and improving productivity and ease of assembly, while increasing workability so as to reduce a price thereof.

Further, another object of the present invention is to provide an LED lighting device that prevents the power supply wire coupled to the connector terminal from being separated, thereby reducing malfunction or non-operation of the LED bar while extending the lifespan of the LED bar.

Further, another object of the present invention is to provide an LED lighting device in which an LED bar can be cut to a desired length by the user without using a separate cutting tool, thereby enabling easy use while minimizing the number of LED bars and preventing connection failures.

In addition, a further object of the present invention is to provide an LED lighting device that can prevent a position of the LED bar provided inside an LED bar protective casing from being distorted during cutting so as to cut a correct portion thereof, thereby preventing damage to the LED bar.

### Technical Solution

In order to solve the above problems, the LED lighting device of the present invention may include: an LED bar in which LEDs are mounted on a printed circuit board at a predetermined interval and a pair of LED bar connection terminals is formed at a predetermined interval on a top and bottom of the printed circuit board on which the LEDS are mounted, wherein the LED bar can be divided into unit LED bars having a predetermined length by cutting the center of the paired LED bar connection terminals; and a connector for connecting the unit LED bars.

Further, the connection terminal of the connector (“connector terminal”) may include: terminal bodies provided in parallel inside a connector housing; a wire coupling member provided at one end of each terminal body; and LED bar connection members provided to face each other at the other end of the terminal body.

Further, the wire coupling member may have a core wire connection groove to be electrically connected by inserting the wire coupling member downward in the upper center of a bent piece vertically bent upward at one end of the terminal body without removing a coating (or sheath) of the wire.

Further, the core wire connection groove may include: a wire sheath fixing groove in which the wire is inserted and secured at a predetermined depth without removal of the wire sheath; a sheath cutout groove formed in the wire sheath fixing groove; and a core wire fixing groove provided to extend below the sheath cutout groove, wherein these grooves may be integrally provided in the form of a two-stepped sill.

Further, the core wire fixing groove may be provided with a core wire separation preventing part, which prevents the core wire from moving (wobbling) in the reverse direction and from being separated, on each inner surface of the groove.

Further, the core wire separation preventing part may be provided such that the inner surfaces of the core wire fixing grooves have a narrow-top and wide-bottom shape with an inclined angle of 3 to 5° relative to each other.

Further, the bent piece may include a lock piece on each side thereof to protrude outward.

Further, the LED bar connection member may include: connecting projections protruding in a curved form from the bottom to the top or from the top to the bottom, respectively; and insertion guide pieces integrally provided in the connecting projections to extend to the outside, respectively.

Further, a short circuit preventing member may be provided between the LED bar connection members.

Further, the short circuit preventing member may be formed of a vinyl material.

Meanwhile, the dividable LED bar may include: an LED bar protective casing which has an LED bar insertion space therein and is provided with an outer cutting guide on the outside; and an LED bar which is inserted into the LED bar insertion space, includes LEDs to be mounted on a printed circuit board at predetermined intervals, and is provided with an inner cutting guide formed at the same position as the outer cutting guide.

Further, the LED bar protective casing may include: a bottom casing member having a flat shape and extending in a longitudinal direction; a side casing member facing upward on both sides of the bottom casing member in the width direction and having a curved shape protruding outwardly; and a top casing member protruding from an end of the side casing member toward the upper center of the bottom casing member to form an arch shape, wherein these members are integrally provided.

Further, the top casing member may be configured to have a larger radius than that of the side casing member.

Further, the top casing member may be transparent.

Further, the outer cutting guide may have an upper notch groove having a “V” shape, a width of which gradually decreases from the surface of the top casing member toward the inside of the top casing member.

Further, the outer cutting guide may have a lower notch groove having a “\hat{ }” shape, a width of which gradually decreases from the surface of the bottom casing member toward the inside of the bottom casing member.

Further, the side casing member may include an LED bar insertion guide disposed on the inside toward the center of the LED bar insertion space, wherein the LED bar insertion guide includes: a horizontal guide arm horizontally protruding from the inside of the side casing member toward the center of the LED bar insertion space; and an LED bar support arm having a channel shape, which is provided at an end of the horizontal guide arm.

Further, the inner cutting guide may include at least one via-hole.

In addition, the LED bar protective casing may be provided with stopper projections on both sides of the LED bar insertion space at a position coincident with the outer cutting guide, while the LED bar may be provided with stopper grooves on both sides of the inner cutting guide in the board, whereby the stopper projections are coupled to the stopper grooves.

### Effect of Invention

In the present invention, the LED bar may be cut to predetermined length and used, and the cut bars may be easily coupled to one another by a connector so that the LED lighting may be easily configured in the figure or letter shape of desired designs, thereby attaining effects of usefully utilizing the same in interior decoration, shop promotion, etc.

Further, the present invention does not use any separate working tool, etc. but connects a power supply wire to a connection terminal of the connector, thereby reducing working time, increasing productivity and ease of assembly, improving workability according to installation works and eventually reducing the price thereof.

Further, the present invention may prevent the power supply wire connected to the connector terminal from being separated, thereby reducing malfunction or non-operation of the LED bar and extending the lifespan of the LED bar.

Further, the present invention enables easy cutting of the LED bar to desired lengths by a user without using a separate cutting tool while minimizing the number of LED bars to be used, thereby reducing working time and attaining effects of preventing occurrence of connection failures.

Further, the present invention may prevent a position of the LED bar inside of the LED bar protective casing from being distorted during cutting, thereby cutting a correct portion and attaining effects of preventing occurrence of damage to the LED bar during cutting.

### BRIEF DESCRIPTION OF DRAWINGS

FIG. 1 is a perspective view illustrating a dividable LED bar according to the present invention.

FIG. 2 is a perspective view illustrating unit LED bars prepared by cutting and dividing the dividable LED bar of the present invention to a predetermined length.

FIG. 3 is a perspective view and a bottom perspective view separately illustrating the unit LED bar prepared by cutting the dividable LED bar according to the present invention to a predetermined length.

FIG. 4 is a perspective view illustrating a state in which a power supply wire and the LED bar are separated from a connection terminal of the connector (“connector terminal”) according to the present invention.

FIG. 5 is a perspective view illustrating the connector housing and the power supply wire, which are separated in a state wherein the LED bar is inserted and connected at the connector terminal according to the present invention.

FIGS. 6a and 6b are each exemplary views showing states before and after the power supply wire is inserted and connected to a wire coupling member at the connector terminal according to the present invention.

FIG. 7 is a sectional perspective view illustrating the inside and outside in a state wherein the power supply wire and the LED bar are connected at the connector terminal according to the present invention.

FIGS. 8a and 8b are perspective views illustrating the LED bar before and after connection in a state wherein the power supply wire is connected at the connector terminal according to the present invention.

FIG. 9 is a perspective view illustrating a dividable LED bar according to another embodiment of the present invention.

FIG. 10 is an exploded perspective view illustrating the dividable LED bar according to another embodiment of the present invention.

FIG. 11 is a longitudinal sectional view illustrating the dividable LED bar according to another embodiment of the present invention.

### PREFERRED EMBODIMENTS OF INVENTION

Hereinafter, specific embodiments of the present invention will be described with reference to the accompanying drawings.

In the description of the present invention, terms such as first and second may be used to specify different components, however, the components may not be limited thereby. These terms are only for distinguishing one component from other components. For example, the first component may be referred to as a second component without departing from the scope of the present invention and, similarly, the second component may be referred to as a first component.

When a component is described as being coupled or connected to another component, it may be understood that other components may exist there between, although the component may also be directly coupled or connected to the other component.

The terms used herein are only used to describe specific embodiments, and are not intended to limit the present invention. Singular expressions may include plural expressions unless the context clearly indicates otherwise.

In the present specification, terms such as “include” or “provided with” are intended to designate the existence of features, numbers, steps, operations, components, parts or combinations thereof described in the specification. However, it may be understood that possible existence or addition of one or more other features, numbers, steps, operations, components, parts or combinations there of is not excluded beforehand.

Further, shapes and sizes of elements in the drawings may be exaggerated for clear explanation.

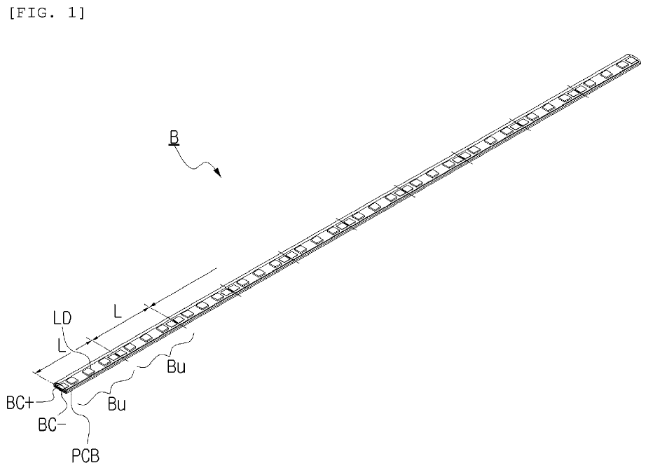

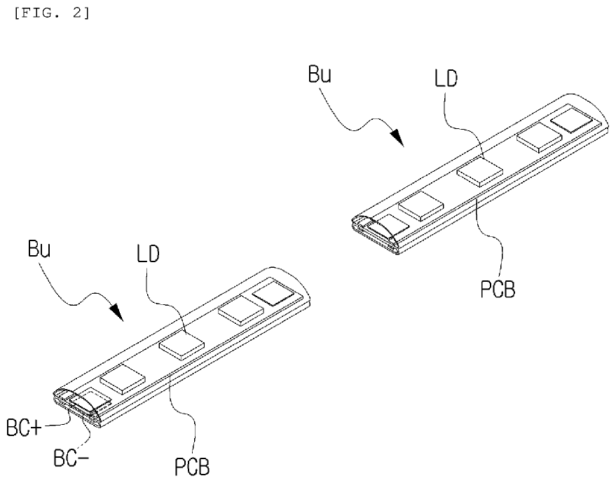

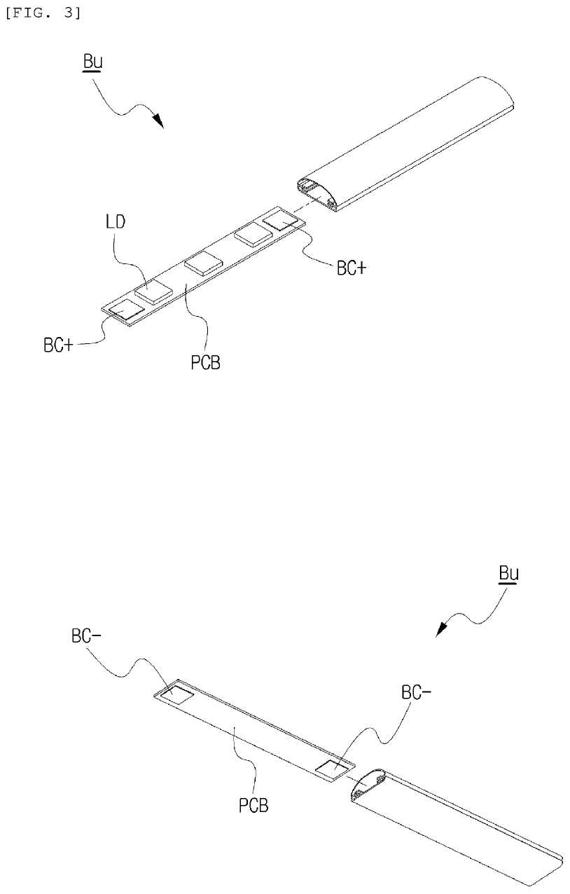

FIG. 1 is a perspective view illustrating a dividable LED bar according to the present invention; FIG. 2 is a perspective view illustrating unit LED bars prepared by cutting and dividing the dividable LED bar of the present invention to a predetermined length; and FIG. 3 is a perspective view and a bottom perspective view separately illustrating the unit LED bar prepared by cutting the dividable LED bar according to the present invention to a predetermined length.

In this regards, the LED bar B may be provided with LEDs (LDs), which are mounted on a printed circuit board PCB at a predetermined interval. Further, a pair of LED bar connection terminals (BC+) and (BC−) may be provided on the top and bottom of the printed circuit board PCB located on both sides of three (3) LEDs (LDs) shown in the drawing, wherein each LED bar connection terminal may be cut to a predetermined length L and used.

At this time, one LED bar B may be cut to a predetermined length L and provided as an unit LED bar (Bu), wherein the unit LED bar Bu may be connected while being inserted into a connection terminal of a connector (“connector terminal”) described later.

The unit LED bar Bu may be provided with LED bar connection terminals (BC+) and (BC−) on both of upper and lower ends, respectively, as shown in FIGS. 2 and 3. An appropriate length of the unit LED bar may be about 5 cm and is preferably prepared and used by cutting the LED bar B to any desired length.

As such, a user may desirably cut one LED bar B to be arranged in a figure or letter pattern of desired designs, followed by combining the same by means of a connector to manufacture LED lighting, whereby the LED lighting may be easily utilized for interior decoration or shop promotion.

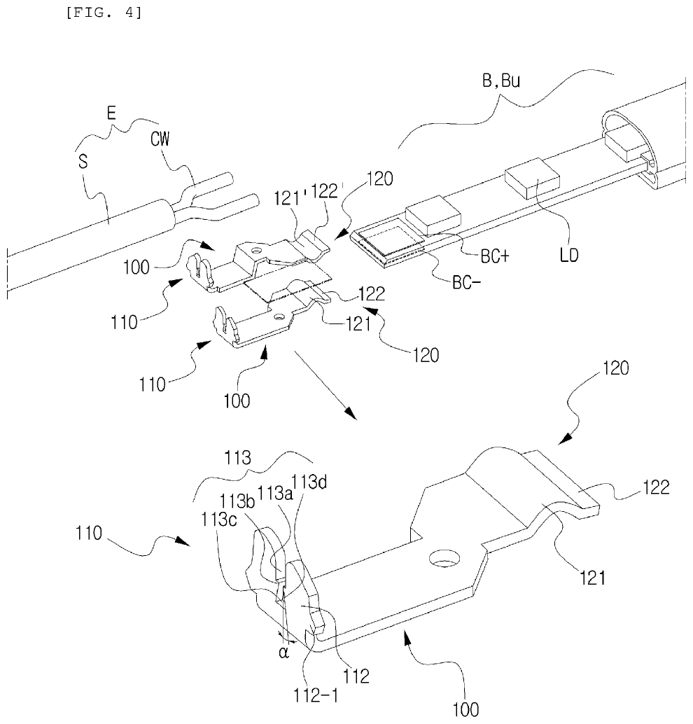

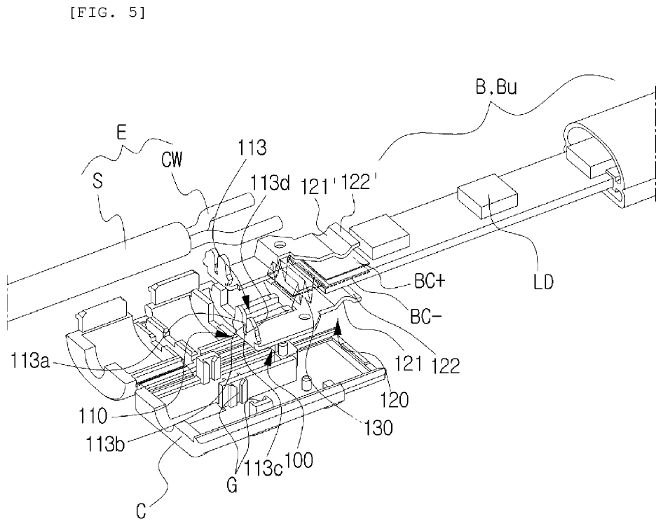

FIG. 4 is a perspective view illustrating a state in which a power supply wire and the LED bar are separated from a connection terminal of the connector (“connector terminal”) according to the present invention; and FIG. 5 is a perspective view illustrating the connector housing and the power supply wire, which are separated in a state wherein the LED bar is inserted into and connected to the connector terminal according to the present invention.

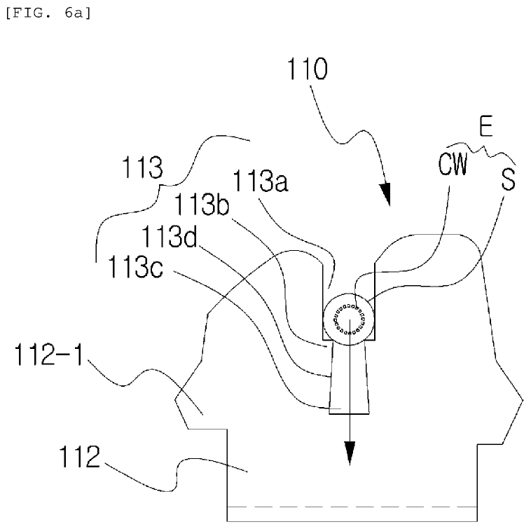

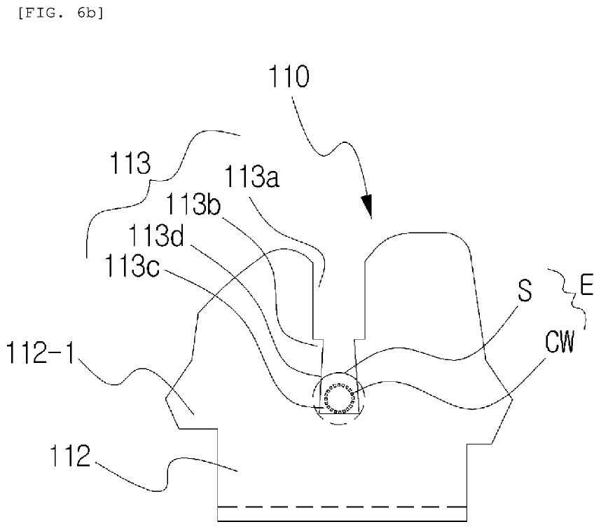

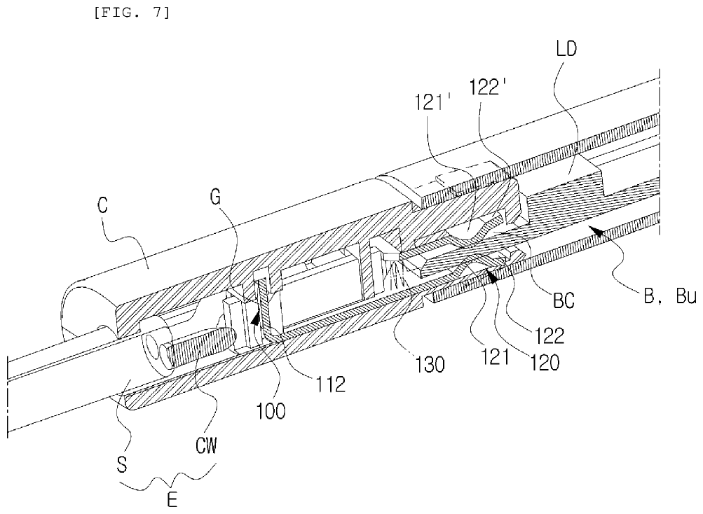

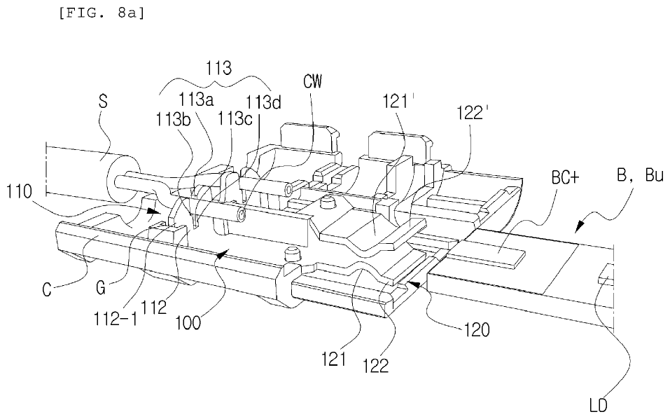

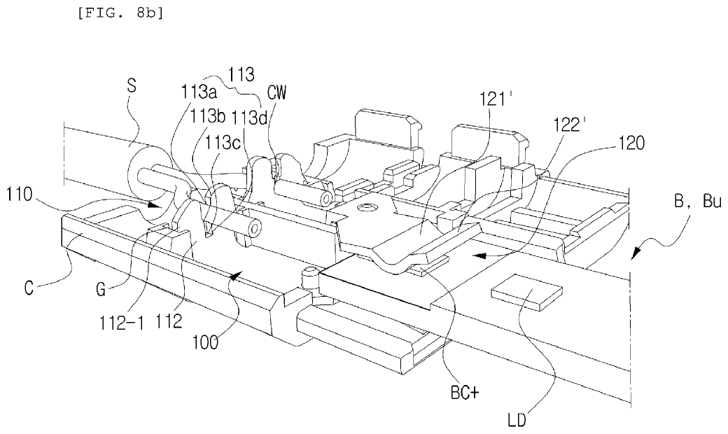

Further, FIGS. 6a and 6b are each exemplary views showing states before and after the power supply wire is inserted into and connected to a wire coupling member at the connector terminal according to the present invention; FIG. 7 is a sectional perspective view illustrating the inside and outside in a state wherein the power supply wire and the LED bar are connected at the connector terminal according to the present invention; and FIGS. 8a and 8b are perspective views illustrating the LED bar before and after connection in a state wherein the power supply wire is connected to the connector terminal according to the present invention.

The connector terminal according to the present invention may enable the power supply wire to be connected to the connector terminal without using a separate working tool, thereby reducing a working time and improving productivity and ease of assembly while preventing separation of the connected power supply wire in a reverse direction and thus preventing malfunction or non-operation of the LED bar.

As shown in FIGS. 4 to 8a and 8b, the connector terminal may include a terminal body 100, a wire coupling member 120 and an LED bar connection member 120, wherein one side of the connector terminal, to which the power supply wire E is connected, is parallel in a horizontal direction inside the connector housing C, while the other side, to which the LED bar B or the unit LED bar Bu is inserted and connected, is parallel in a vertical direction.

Herein, the terminal body 100 may consist of a conductor and may be provided in parallel to the inside of the connector housing C, in which the middle portion is formed in a hinge shape to open and close the housing, wherein + power is supplied to one terminal body while − power is supplied to the other.

The wire coupling member 110 may be provided at one end of each terminal body 100 wherein a bent piece 112 vertically bent upward is present at one end of the terminal body 100 and a core wire connection groove 113 is formed in the upper center of the bent piece 112, so that the power supply wire E can be simply inserted and connected without stripping off a sheath S of the wire.

The core wire connection groove 113 may include a wire sheath fixing groove 113a, a sheath cutout groove 113b and a core wire fixing groove 113c, which are integrally configured to have the form of a two-stepped sill, wherein the wire sheath fixing groove 113 is formed to have a predetermined depth from the top to the bottom, and a width or spacing is the same length as a sheath diameter of the power supply wire E, whereby the connection groove 113 is inserted and stopped at a predetermined depth without removing the sheath S.

The sheath cutout groove 113b may be formed in the center at the bottom of the wire sheath fixing groove 113a and have a width or spacing, which is the same as a diameter of the core wire CW of the power supply wire E, so that the sheath S is peeled off while the power supply wire E passes through the sheath cutout groove 113b, thereby exposing the core wire CW.

The core wire fixing groove 113c may be provided to extend toward the bottom of the sheath cutout groove 113b, whereby the sheath-removed core wire CW can be seated and connected simultaneously. At this time, the core wire fixing groove 113c may include a core wire separation preventing part 113d on each inner surface so as to prevent the core wire CW from moving (or wobbling) and being separated in the reverse direction, thereby preventing short circuit.

The core wire separation preventing part 113d may be provided such that the inner surface of the core wire connection fixing groove 113c is in a narrow-top and wide-bottom shape having an inclined angle α of 2 to 6° to the vertical so as to press both sides of the core wire CW from the top toward the bottom, thereby preventing the same from wobbling in the reverse direction and separation thereof.

At this time, the inclined angle α is more preferably in the range of 3 to 5° and, if this angle is less than 2°, the width is narrow and the core wire CW is hardly inserted into the bottom of the core wire fixing groove 113c and may sometimes break during insertion. Further, when the inclined angle is 6° or more, the width is too wide to prevent wobbling due to low pressure applied to the surface of the core wire CW.

The bent piece 112 may be provided with a lock piece 112-1 protruding outward on each of both sides, which prevents the core wire from being inserted into a groove G inside the connector housing C by more than a predetermined depth while preventing the core wire from wobbling to the left and right in the inserted state, whereby the terminal body 100 may be stably supported.

The LED bar connection member 120 may be connected to the LED bar connection terminals (BC+) and (BC−) provided on upper and lower ends of the LED bar B or the unit LED bar Bu, and may be provided such that connection can be easily completed by simply inserting the end of the LED bar B or the unit LED bar Bu.

To this end, the LED bar connection member 120 may be provided with connecting projections 121 and 121′, which face each other at the top and bottom of the other end of each terminal body 120, and protrude to be curved from the bottom to the top or from the top to the bottom, whereby the LED bar connection terminals (BC+) and (BC−) can be inserted and connected simultaneously.

The connecting projections 121 and 121′ may include insertion guide pieces 122 and 122′, which are integrally included to extend outwardly, whereby the end provided with the LED bar connection. terminals (BC+) and (BC−) can be easily inserted without interference.

On the other hand, a separate short circuit preventing member 130 may be provided between the LED bar connection members 120, in order to prevent occurrence of short circuit during insertion or separation. The short circuit preventing member 130 may be formed of a vinyl material with insulating properties. Such a vinyl material has a thin and flat shape and, when an end of the LED bar B or the unit LED bar Bu is inserted, may be folded inward in a zigzag form during insertion. Therefore, it is possible to prevent application of electric current from being interrupted due to the short circuit preventing member 130 sandwiched between the connecting projections 121 and 121′ and the LED bar connection terminal BC.

A process of installing electric wires in the connection terminal of the connector (“connector terminal”) according to the present invention will be described below.

When the electric wire is present inside the connector housing C, the connector housing C may be first opened to expose the terminal body 100 to the outside. Then, as shown in FIG. 6a, the power supply wire E may be inserted into the core wire connection groove 113 of the wire coupling member 110 provided at one end of the terminal body 100 in order to be seated in the wire sheath fixing groove 113a without stripping off the sheath S.

Next, while pressing the power supply wire E downward, the sheath S of the power supply wire E may be cutout by the sheath cutout groove 113b. On the other hand, as shown in FIG. 6b, the core wire CW may be inserted into the core wire fixing groove 113c and easily connected simultaneously. Thereafter, the opened connector housing C is closed to complete connection of the power supply wire E.

Meanwhile, a process of connecting the LED bar B to the connector according to the present invention will be described below. First, as shown in FIG. 8a, the end of the LED bar B, that is, the LED bar provided with the LED bar connection terminals (BC+) and (BC−) is disposed between the insertion guide pieces 122 and 122′ of the LED bar connection member 120, followed by inserting the LED bar B into the same. Therefore, as shown in FIG. 8b, the end of the LED bar B may be inserted and connected between the connecting projections 121 and 121′, simultaneously, under guidance of the insertion guide pieces 122 and 122′. Accordingly, LEDs provided on the LED bar B can be turned on and off at the same time as power is applied.

According to the present invention as described above, the LED bar B may be cut to a predetermined length to be used and such cut bars may be easily coupled by a connector, so that the figure or letter pattern of desired designs can be easily created with LED lighting, thereby attaining effects of usefully utilizing the same in interior decoration, shop promotion, etc.

Further, according to the present invention, the power supply wire may be connected to a connector terminal without using a separate working tool, thereby reducing working time, increasing productivity and ease of assembly, improving workability according to installation work and eventually reducing the price thereof. Further, it is possible to prevent the power supply wire connected to the connector terminal from being disconnected, thereby reducing malfunction or non-operation of the LED bar while extending the lifespan of the LED bar.

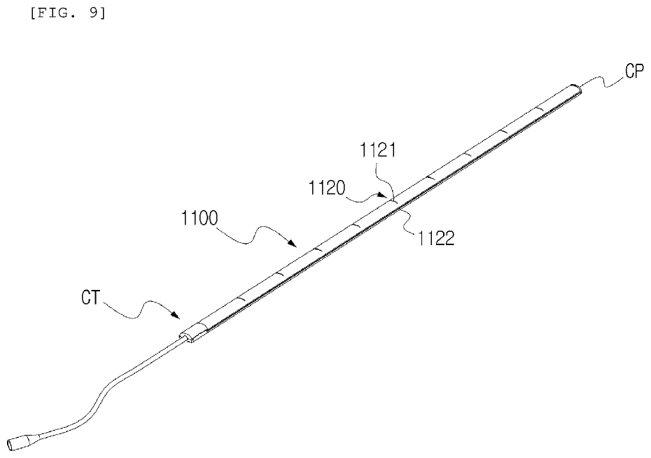

Hereinafter, a dividable LED bar according to another embodiment of the present invention will be described with reference to FIGS. 9 to 11.

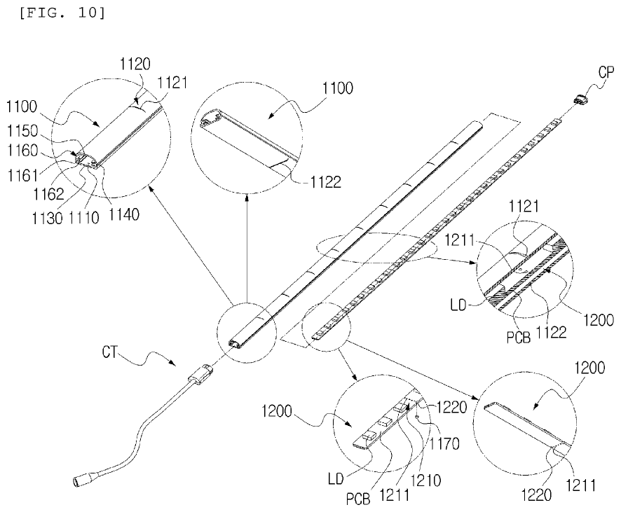

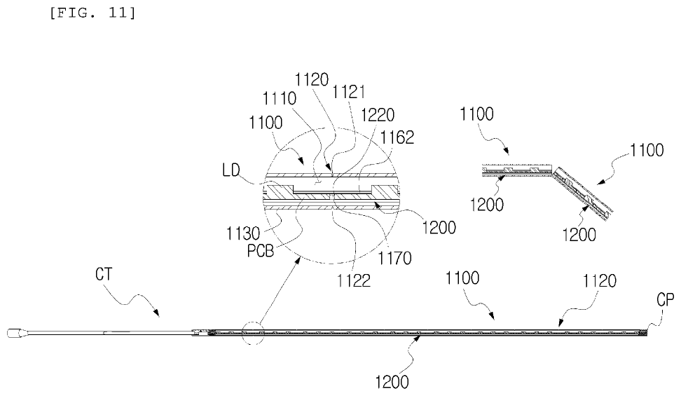

FIG. 9 is a perspective view illustrating a dividable LED bar according to another embodiment of the present invention; FIG. 10 is an exploded perspective view illustrating the dividable LED bar according to another embodiment of the present invention; and FIG. 11 is a longitudinal sectional view illustrating the dividable LED bar according to another embodiment of the present invention.

The dividable LED bar according to the present invention may be cut to a length desired by the user without using a separate cutting tool and also be cut at a correct portion to be cut in a cutting process, thereby preventing damage to the LED bar. As shown in FIGS. 9 to 11, an LED bar protective casing 1100 and an LED bar 1200 may be included.

In this regard, the LED bar protective casing 1100 may have an LED bar insertion space 1110 and may be provided with outer cutting guides 1120 which are repeated with a predetermined length in a longitudinal direction on the outside.

The LED bar protective casing 1100 may be formed of synthetic resin and manufactured by cutting the synthetic resin extrusion-molded in a longitudinal direction to a predetermined length to be used. The casing 1100 has a flat shape and may be provided with side casing members (“side members”) 1140 on both sides in a width direction of a bottom casing member (“bottom member”) 1130 extending in a longitudinal direction.

Each side member 1140 may be configured to protrude upward while being curved outwardly, so that the LED bar 200 can be stably inserted. Further, a top casing member (“top member”) 1150 may be integrally provided while protruding in an arch shape from an end of the side member 1140 to the upper center of the bottom member 1130.

At this time, the top member 1150 may be transparent and have a larger radius than that of the side member 1140, whereby the LED bar 1200 in the casing can be isolated from the outside and protected from foreign matter or impurities while being stably inserted. Further, it is possible to prevent glare due to light emitted from LEDs (LDs) mounted on the printed circuit board (PCB) described later, while transmitting the light to the outside.

The side member 1140 may include an LED bar insertion guide 1160 disposed on the inner surface toward the center of the LED bar insertion space 1110. The LED bar insertion guide 1160 may be provided with a horizontal guide arm 161 protruding horizontally from the inner surface of the side member 140 toward the center of the LED bar insertion space 1110.

Further, an LED bar support arm 1160 in a channel shape may be provided at an end of the horizontal guide arm 1161, so that both ends of the LED bar 1200 in a width direction can be continuously inserted in a sliding mode.

In the present invention, although the side member 1140 has an outwardly convex shape, a long guide groove haying a concave groove shape on. the outside or outer surface thereof may also be formed in a longitudinal direction. In this case, a bracket or the like is preferably used to easily couple or secure the side member, instead of using a separate adhesive means.

Meanwhile, as shown in the upper right side of FIG. 11, the outer cutting guide 1120 may allow the LED bar protective casing 1100 to be easily bent or broken when force is applied in the front or rear direction while holding one side and the other side of the LED bar protective casing 110 with both hands. This guide may include an upper notch groove 1121 in a “V” shape having a width gradually decreasing from the surface of the top member 1150 toward the inside thereof.

Further, the outer cutting guide 1120 may also include a lower notch groove 1122 in a “\hat{ }” shape having a width gradually decreasing from the surface of the bottom member 1130 toward the inside thereof, in addition to the upper notch groove 1121 provided on the surface of the top member 1150. Accordingly, the location can be cut more accurately. That is, the LED bar protective casing 1100 may be cut with reference to the upper notch groove 1121 and the lower notch groove 122 in a process of repeatedly folding or unfolding several times in front and rear directions while holding one side and the other side of the LED bar protective casing with both hands.

The LED bar protective casing 1100 may be provided with stopping projections 1170 on both sides of the LED bar insertion space 1110 at positions coincident with the outer cutting guide 1120, and the stopping projections may be coupled to stopping grooves 1220 formed on the board (PCB) of the LED bar 1200 described later, whereby occurrence of wobble during cutting can be prevented while cutting the correct portion to be cut.

The LED bar 1200 may be inserted. into the LED bar insertion space 1110 of the LED bar protective casing 1100, wherein LEDs (LDs) are mounted at a predetermined interval in a printed circuit board PCB in a band shape with a longer length in the longitudinal direction than that in the width direction.

At the same position on which the outer cutting guide 1120 of the LED bar protective casing 1100 is provided, an inner cutting guide 1210 consisting of at least one or more via-holes 1211 may be provided, thereby cutting the same position as the outer cutting guide 1120 of the LED bar protective casing 1100.

At both sides of the inner cutting guide 1210 of the board PCB to configure the LED bar 1200, the stopping groove 1220 may be formed so that the stopping projections 1170 provided at both sides of the LED bar insertion space 1110 of the LED bar protective casing 1100 are coupled to the above stopping grooves, thereby preventing occurrence of wobble in the LED bar 1200 and the board PCB during cutting.

While adjusting both ends of the printed circuit board PCB to match LED bar support arms 1162 of the LED bar insertion guide 1160 provided on both sides of the LED bar insertion space 1110 of the LED bar protective casing 1100, both ends of the printed circuit board PCB may be inserted in a sliding mode along the LED bar insertion guide 1160 by pressing the printed circuit board PCB in a longitudinal direction.

At this time, the stopping projection 1170 may be fitted in the stopping groove 1220 in the printed circuit board PCB while preventing the printed circuit board PCB from being inserted in a longitudinal direction. However, when applied load is further increased, a gap between the stopping grooves 1220 widened to induce continuous sliding movement. As a result, the other side of the printed circuit board PCB becomes coincident with the other side of the LED bar protective casing 1100 and, at the same time, the LED bar 1200 provided with the inner cutting guide 1210 may be inserted into the LED bar insertion space 1110 of the LED bar protective casing 1100.

With regard to the dividable LED bar obtained by the above processes according to the present invention, when force is applied in the front or rear direction while holding one side and the other side of the LED bar protective casing 1100 with both hands, this casing 1100 may be cut by the upper notch groove 1121 on the surface of the top member 1150 and the lower notch groove 1122 on the surface of the bottom member 1130. At the same time, the board PCB to configure the LED bar 1200 may be cut by the inner cutting guide 1210 consisting of via-holes 1211.

In this case, the board PCB tends to move in a longitudinal direction while cutting the same by the inner cutting guide 1210 consisting of via-holes 1211. However, since the stopping grooves 1220 on both sides of the inner cutting guide 1210 are coupled to the stopping projections 1170 on both sides of the LED bar insertion space 1110 of the LED bar protective casing 1100, wobbling of the board PCB may be prevented during cutting, thereby enabling accurate cutting.

According to the present invention as described above, the LED bar can be easily cut to a desired length by the user without using a separate cutting tool while minimizing the number of LED bars to be used, thereby reducing working time and attaining effects of preventing connection failures.

Further, it is possible to prevent a position of the LED bar inside the LED bar protective casing from being distorted during cutting, thereby enabling the correction portion to be cut. Therefore, effects of preventing damage to the LED bar occurring in the cutting process may also be achieved.

As described above, the present invention has been described with reference to the illustrated embodiment in the drawings, however, these are merely exemplary and the present invention is not particularly limited by the above embodiments and drawings, instead, various modifications thereof may be possible by those skilled in the art within the technical scope of the invention. Accordingly, the technical scope of the present invention to be protected should be defined only by the technical spirit of the appended claims.

### DESCRIPTION OF REFERENCE NUMERALS

100: Terminal body 110: Wire coupling member
112: Bent piece 112-1: Lock piece
113: Core wire connection groove 113a: Wire sheath fixing groove
113b: Sheath cutout groove 113c: Core wire fixing groove
113d: Core wire separation preventing part 120:LED bar connection member
121, 121° : Connecting projection 122,122′: Insertion guide piece
130: Short circuit preventing member
1100: LED bar protective casing 1110: LED bar insertion space
1120: Outer cutting guide 1121: Upper notch groove
1122: Lower notch groove 1130: Bottom casing member
1140: Side casing member 1150: Top casing member
1160: LED bar insertion guide 1161: Horizontal guide arm
1162: LED bar support arm 1170: Stopping projection
1200: LED bar 1210: Inner cutting guide
1211: Via-hole 1220: Stopping groove
PCB: Printed circuit. board LD: LED

### INDUSTRIAL APPLICABILITY

The present invention relates to an LED lighting device and is applicable to the field of LED lighting.

1. An LED lighting device, comprising:
an LED bar in which LEDs are mounted on a printed circuit board at a predetermined interval and a pair of LED bar connection terminals is formed at a predetermined interval on a top and bottom of the printed circuit board on which the LEDS are mounted, wherein the LED bar is dividable into unit LED bars having a predetermined length by cutting a center of a paired LED bar connection terminals; and
a connector for connecting the unit LED bars.

2. The LED lighting device according to claim 1, wherein a connection terminal of the connector (“connector terminal”) includes:
terminal bodies provided in parallel inside a connector housing;
a wire coupling member provided at one end of each terminal body; and
LED bar connection members provided to face each other at an other end of the terminal body.

3. The LED lighting device according to claim 2, wherein the wire coupling member is provided with a core wire connection groove to be electrically connected by inserting the wire coupling member downward in an upper center of a bent piece vertically bent upward at one end of the terminal body without peeling off a coating (or sheath) of the wire.

4. The LED lighting device according to claim 3, wherein the core wire connection groove includes:
a wire sheath fixing groove in which the wire is inserted and secured at a predetermined depth without removal of the wire sheath;
a sheath cutout groove formed in the wire sheath fixing groove; and
a core wire fixing groove provided to extend below the sheath cutout groove, wherein these grooves are integrally provided in a form of a two-stepped sill.

5. The LED lighting device according to claim 4, wherein the core wire fixing groove is provided with a core wire separation preventing part, which prevents the core wire from moving (or wobbling) in a reverse direction and from being separated, on each inner surface of the groove.

6. The LED lighting device according to claim 5, wherein the core wire separation preventing part is provided such that inner surfaces of the core wire fixing grooves have a narrow-top and wide-bottom shape with an inclined angle of 3 to 5° relative to each other.

7. The LED lighting device according to claim 3, wherein the bent piece includes a lock piece on each side thereof to protrude outward.

8. The LED lighting device according to claim 2, wherein the LED bar connection member includes:
connecting projections protruding in a curved form from a bottom to a top or from a top to the bottom, respectively; and insertion guide pieces integrally provided in the connecting projections to extend to a outside, respectively.

9. The LED lighting device according to claim 2, wherein a short circuit preventing member is provided between the LED bar connection members.

10. The LED lighting device according to claim 9, wherein the short circuit preventing member is formed of a vinyl material.

11. The LED lighting device according to claim 1, wherein the dividable LED bar includes:
an LED bar protective casing which has an LED bar insertion space therein and is provided with an outer cutting guide on an outside; and
an LED bar which is inserted into the LED bar insertion space, includes LEDs to be mounted on a printed circuit board at predetermined intervals, and is provided with an inner cutting guide formed at the same position as the outer cutting guide.

12. The LED lighting device according to claim 11, wherein the LED bar protective casing includes:
a bottom casing member having a flat shape and extending in a longitudinal direction;
a side casing member facing upward on opposite sides of the bottom casing member in the width direction and having a curved shape protruding outwardly; and
a top casing member protruding from an end of the side casing member toward the upper center of the bottom casing member to form an arch shape, wherein these members are integrally provided.

13. The LED lighting device according to claim 12, wherein the top casing member is configured to have a larger radius than that of the side casing member.

14. The LED lighting device according to claim 12, wherein the top casing member is transparent.

15. The LED lighting device according to claim 11, wherein the outer cutting guide includes an upper notch groove having a “V” shape, a width of which gradually decreases from the surface of the top casing member toward the inside of the top casing member.

16. The LED lighting device according to claim 11, wherein the outer cutting guide has a lower notch groove having a “\hat{ }” shape, a width of which gradually decreases from the surface of the bottom casing member toward the inside of the bottom casing member.

17. The LED lighting device according to claim 12, wherein the side casing member includes an LED bar insertion guide disposed on the inside toward the center of the LED bar insertion space, wherein the LED bar insertion guide includes: a horizontal guide arm horizontally protruding from the inside of the side casing member toward the center of the LED bar insertion space; and
an LED bar support arm having a channel shape, which is provided at an end of the horizontal guide arm.

18. The LED lighting device according to claim 11, wherein the inner cutting guide includes at least one via-hole.

19. The LED lighting device according to claim 11, wherein the LED bar protective casing is provided with stopper projections on both sides of the LED bar insertion space at a position coincident with the outer cutting guide, and
the LED bar is provided with stopper grooves on both sides of the inner cutting guide in the board, whereby the stopper projections are coupled to the stopper grooves.
